(19) United States
(12) Patent Application Publication
(10) Pub. No.: US 2007/0210546 A1
(43) Pub. Date: Sep. 13, 2007

(54) WHEELED WASTE COLLECTION CONTAINER

(75) Inventors: Donald C. Presnell, Stephens City, VA (US); Michael Severa, Winchester, VA (US)

Correspondence Address: FOLEY AND LARDNER LLP;SUITE 500, 3000 K STREET NW, WASHINGTON, DC, 20007, US

(73) Assignee: Rubbermaid Commercial Products LLC

(21) Appl. No.: 11/682,711

(22) Filed: Mar. 6, 2007

Related U.S. Application Data
(60) Provisional application No. 60/778,848, filed on Mar. 6, 2006.
(60) Provisional application No. 60/849,001, filed on Oct. 4, 2006.

(51) Int. Cl. B62B 3/00

(52) U.S. Cl. 280/47.35

(57) ABSTRACT

One embodiment of the invention relates to a portable receptacle including a container having an open top and including a first portion defining a first space configured to receive a first bag and having a support member to support at least a portion of the periphery of the first bag, and a second portion defining a second space configured to receive a second bag. The portable receptacle further includes a bag support including structure for connection to the container such that the bag support can be disposed between the first portion and the second portion in an orientation that permits the bag support in conjunction with the support member to support at least a portion of the periphery of the first bag such that at least a portion of the first bag is disposed within the first space, and relocated such that the bag support is no longer disposed between the first portion and the second portion. The portable receptacle further includes rolling members supporting the container for movement.

### CROSS-REFERENCE TO RELATED PATENT APPLICATIONS

This application claims priority from U.S. Provisional Application Nos. 60/778,848, filed Mar. 6, 2006 and 60/849,001, filed Oct. 10, 2006, which are incorporated herein by reference in their entireties.

### BACKGROUND

Building service contractors often perform office waste pick-up after hours in office buildings. The task of removing waste from desk-side wastebaskets typically has been accomplished by placing the trash from the wastebaskets in large 44 gallon or 55 gallon round waste containers fitted with polybag liners and supported on dollies. The large waste containers are moved around the office building to gather the trash from all the wastebaskets. As the polybag liners become full, they are removed from the large waste containers and moved to a temporary storage location, such as near an elevator.

Problems are encountered using this technique and equipment. For example, the full polybags can get extremely heavy when filled with office trash. Workers complain of back strain and injuries from having to pull these bags out of the large containers. Additionally, the filled bags must be taken to the elevator and left there for another worker to haul them down the elevator to the basement or dock trash bins. The repeated trips back and forth to the elevator cost the deskside workers much time and productivity. Furthermore, many offices are now recycling paper, etc., and provisions for disposing of this second waste stream must be made as the deskside workers travel from desk to desk emptying trash.

Some workers have tried using janitor carts to perform this trash removal function, by using a 44 gallon barrel attached to the front of the cart to hold the main waste stream (general trash) and using the bag in the handle area to hold recycle-able refuse. This still presents problems. The heavy poly-bag still must be lifted up and over the rim of the large barrel, and many trips must be made to and from the elevator dropping off each full bag of waste. The janitor cart is better used as a tool for cleaning restrooms and large public areas, not desk-side trash pick-up.

### SUMMARY

One embodiment of the invention relates to a portable receptacle including a container having an open top and including a first portion defining a first space configured to receive a first bag and having a support member to support at least a portion of the periphery of the first bag, and a second portion defining a second space configured to receive a second bag. The portable receptacle further includes a bag support including structure for connection to the container such that the bag support can be disposed between the first portion and the second portion in an orientation that permits the bag support in conjunction with the support member to support at least a portion of the periphery of the first bag such that at least a portion of the first bag is disposed within the first space, and relocated such that the bag support is no longer disposed between the first portion and the second portion. The portable receptacle further includes rolling members supporting the container for movement.

Another embodiment of the invention relates to a method of filling bags in a portable receptacle. The method includes moving into position a portable receptacle. The portable receptacle includes a container with a first portion defining a first space configured to receive a first bag, and a second portion defining a second space configured to receive a second bag, a bag support including structure for connection to the container such that the bag support can be disposed between the first portion and the second portion and relocated such that the bag support is no longer disposed between the first portion and the second portion, and rolling members supporting the container for movement. The method further includes placing a first bag on the bag support such that the first bag is in the first portion of the container, at least partially filling the first bag, and removing the first bag from the bag support and transferring the first bag to the second portion.

### BRIEF DESCRIPTION OF THE DRAWINGS

FIG. 1A is an isometric view of a portable receptacle according to an exemplary embodiment.

FIG. 1B is an isometric view of the portable receptacle of FIG. 1 with a bag and a container positioned therein.

FIG. 2 is a side view of the portable receptacle of FIG. 1A

FIG. 3 is a rear view of the portable receptacle of FIG. 1A showing an access door in the rear wall.

FIG. 4 is a top view of the portable receptacle in FIG. 1A.

FIGS. 5A-5C are isometric views of the portable receptacle in FIG. 1 showing the bag support being moved from a first position to a second position.

FIG. 6 is a partial isometric view of the access door in FIG. 3 showing a detent structure.

FIG. 7 is a partial isometric view of the access door in FIG. 3 showing a latch member in an unlocked position.

FIG. 8 is a partial isometric view of the access door in FIG. 3 showing the latch member in a locked position.

FIG. 9 is a partial cross-sectional view showing the latch member.

FIG. 10 is a partial exploded view showing the latch member.

FIG. 11 is an isometric view of a plate of the latch member.

FIG. 12 is a bottom view of the portable receptacle in FIG. 1 showing the diamond pattern arrangement of the wheels.

FIGS. 13A-13C are schematic side views of the portable receptacle of FIG. 1 showing an exemplary method of filling bags in the portable receptacle.

### DETAILED DESCRIPTION OF THE PREFERRED EMBODIMENTS

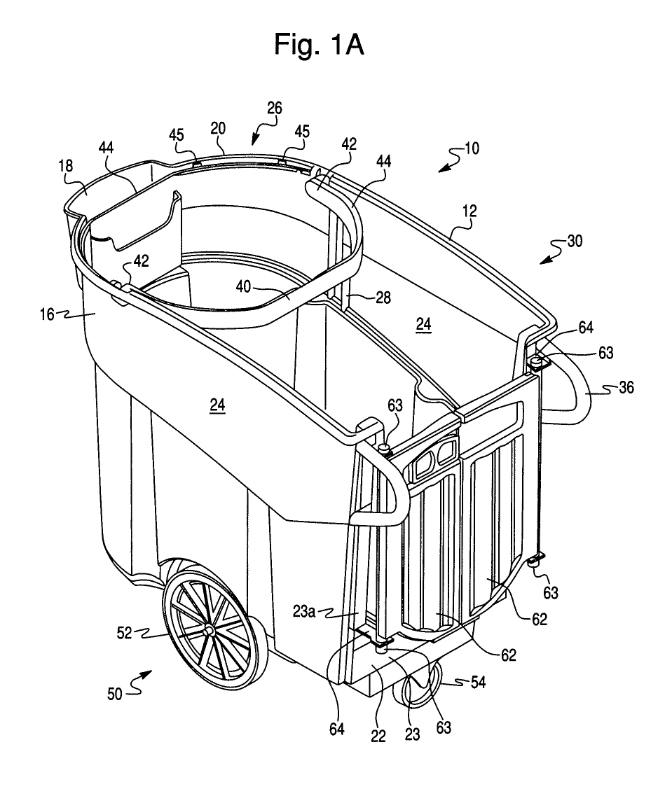

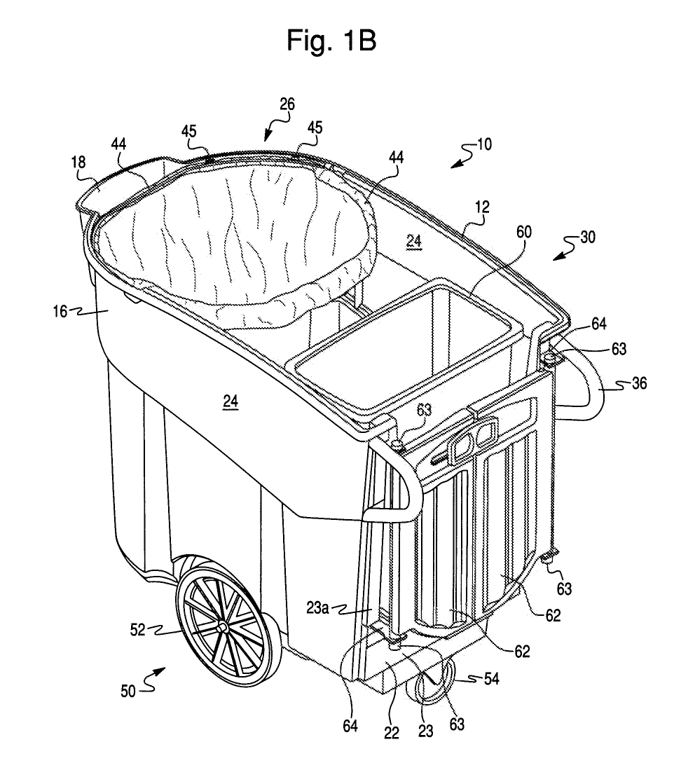

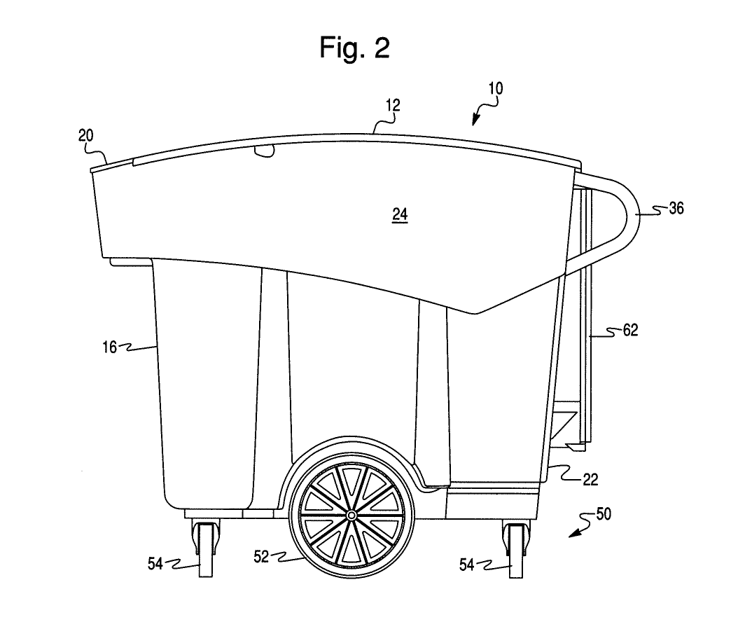

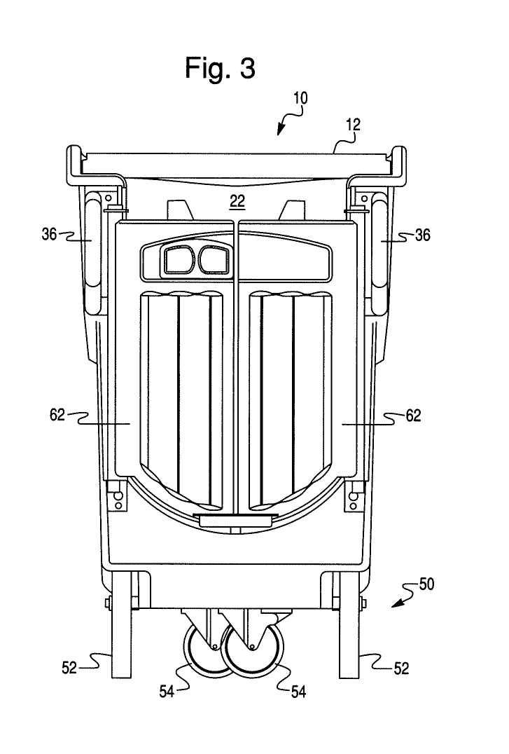

Embodiments of the present invention will now be described with reference to the drawings. Referring to FIG. 1A, a receptacle 10 is shown according to an exemplary embodiment. The receptacle 10 is an elongated open-topped body that is configured to receive one or more bags (i.e., garbage bags). The receptacle 10 includes a main body or container 12, a moveable bag support 40 coupled to the container, and rolling members 50.

The main body 12 includes a bottom or floor 14, a front wall 16 that extends generally upward from the floor 14, a rear wall 22 that extends upward from the floor 14 generally opposite of the front wall 16, and two side walls 24 that extend upward from the floor 14 generally perpendicular to the front 16 and rear 22 walls. The front wall 16 is a curved member that forms a generally smooth continuous surface between the two side walls 24. According to an exemplary embodiment the floor 14, front wall 16 and side walls 24 of the main body 12 are formed from an injection molded polymer such as a high-density polyethylene (HDPE) or other comparable plastic resin. According to other exemplary embodiments, those portions of the main body 12 may be formed from metal, fiberglass, or other suitable material. A lower portion 23 of the rear wall 22 preferably is formed at least in part from metal (and may include a molded HDPE section) and is coupled to the side walls 24 and floor 14. Access doors 62 (described in more detail below) can form an upper portion of the rear wall 22, and the doors 62 are preferably formed of HDPE.

A storage area 18 is provided on the front wall 16 and can be formed as a single unitary body with the front wall 16. The storage area 18 is a vessel that is configured to receive tools or cleaning supplies (e.g., spray bottles, sponges, rags, etc.) that may be needed by a user of the portable receptacle 10. According to one exemplary embodiment, a single storage area 18 is provided on the front wall. According to other exemplary embodiments multiple storage areas may be provided on the front wall 16 or at other locations on the main body 12. According to other exemplary embodiments the storage area may be formed as a separate element from the main body 12 and may be coupled to the main body 12 with mechanical fasteners or other suitable fastening methods.

The main body 12 forms a first portion 26 proximate to the front wall 16 that is configured to receive a first bag and a second portion 30 proximate to the rear wall 22 that is configured to receive a second bag.

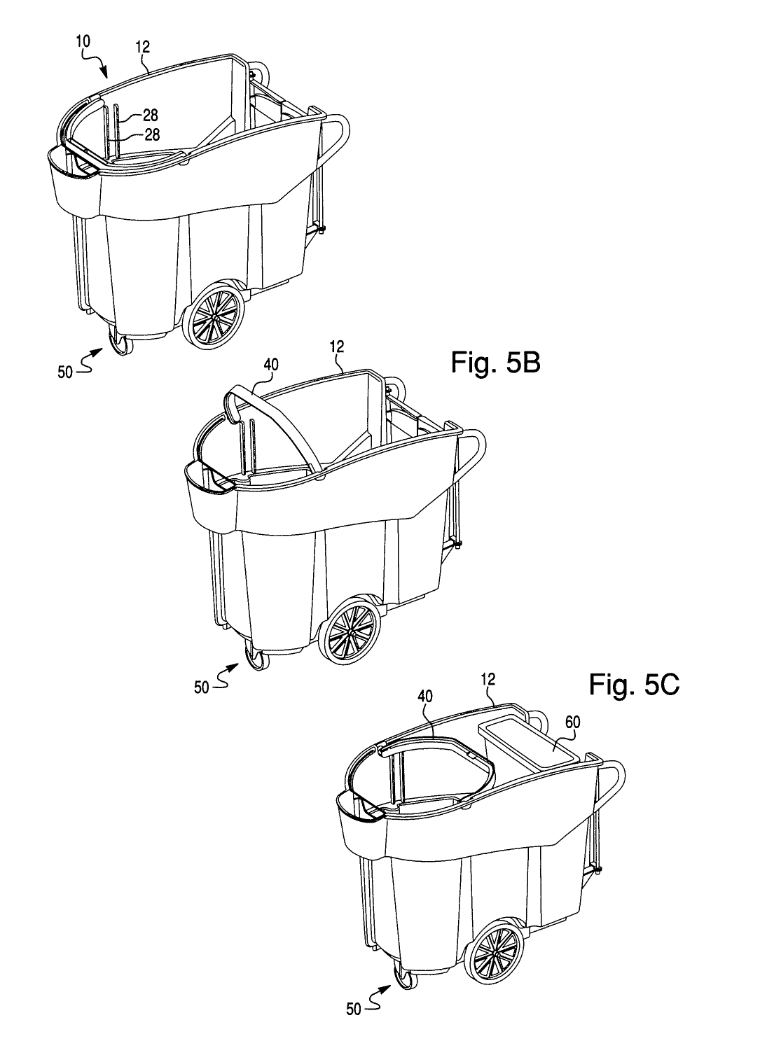

The first portion 26 can include a moveable bag support 40 and a support member 20 along the top of the front wall 16 that support at least a portion of the first bag or liner. According to an exemplary embodiment the bag support 40 is an elongated member (e.g., bar, band, rod, etc.) that is formed into a substantially arcuate shape. According to an exemplary embodiment the bag support 40 is formed from HDPE. According to other exemplary embodiments, the bag support may be formed from any other suitable material. The bag support 40 is pivotably coupled to the first portion 26 of the main body 14 on either end 42. The bag support 40 is moveable between a first or retracted position (FIG. 5A) in which it is horizontal and generally follows the contour of the front wall 16 and a second or use position (FIG. 5C) in which it is disposed approximately 180 degrees from the retracted position. In the retracted position, the main body 12 is essentially undivided and can accommodate large items. In the use position, the bag support 40 divides the main body 12. In this position, the bag support 40 and front wall 16 generally form a circle and can be used to support a first bag so that the bottom portion of the bag is received in the first portion 26 of the receptacle 10.

The first portion 26 includes one or more stops 28 (e.g., fins, walls, protrusions, flanges, etc.) that extend inward from at least one of the side walls 24. These stops 28 limit the rotation of the bag support 40 and provide a ledge for the bag support 40 to rest on when it is supporting the weight of any material held in the bag.

A wire bail 44 may be included along each of the support structure 20 and bag support 40 to facilitate coupling the first bag to the support structure 20 and the bag support 40. The wire bails 44 can be configured as substantially half circles, with their ends pivotally mounted to the main body 12 or the bag support 40. Conventional protrusions or catches 45 can be provided to hold the wire bails 44 in position

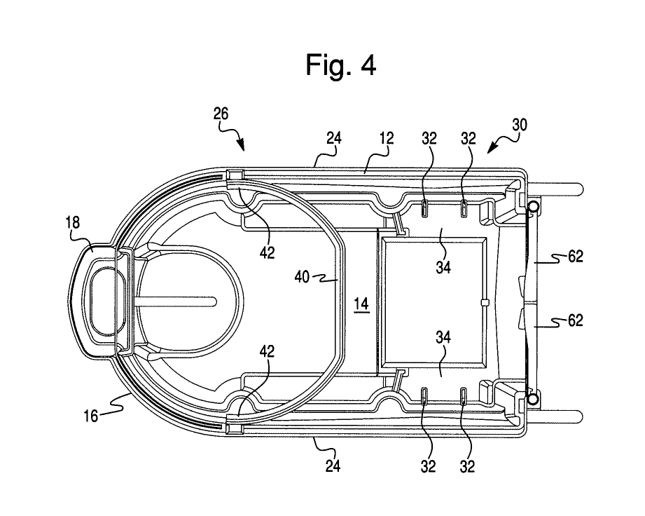

The second portion 30 can be configured to receive a second bag. The second portion 30 more preferably is configured to receive a container 60 (e.g., trash bin, trash can, receptacle, etc.), which will receive the second bag. As shown best in FIG. 4, one or more generally vertical walls 32 (e.g., fins, projections, flanges, etc.) extend inward from the side walls 24 and are configured to at least partially position the container 60 within the second portion 30. The floor 14 may include one or more raised portions 34 proximate to the side walls 24 that are configured to support the container 60.

The rear wall 22 can include one or more access doors that allow bags to be removed from the main body 12 laterally without having to lift them up and over the front 16, rear 22, or side walls 24. According to an exemplary embodiment the rear wall 22 includes two doors 62 that may be opened to allow bags to be pulled from the second portion of the receptacle 10. The metal portion 23 of the rear wall 22 allows the container to be generally rigid even when the doors 62 are open.

The doors 62 preferably are hingedly connected to upwardly extending portions 23a of the rear wall 22 such that they can swing between open and closed positions. The doors 62 can have round bosses 63 that rotatably fit within holes in flanges 64, which project from the upwardly extending portions 23a. The bosses 63 preferably allow sufficient play in the vertical direction such that the doors can be moved upwardly in a range of about three quarters of an inch.

The doors 62 can be held in the closed position by a variety of means. In the preferred embodiment shown in the drawings, the doors 62 are held closed by a detent structure 80 and a latch member 90.

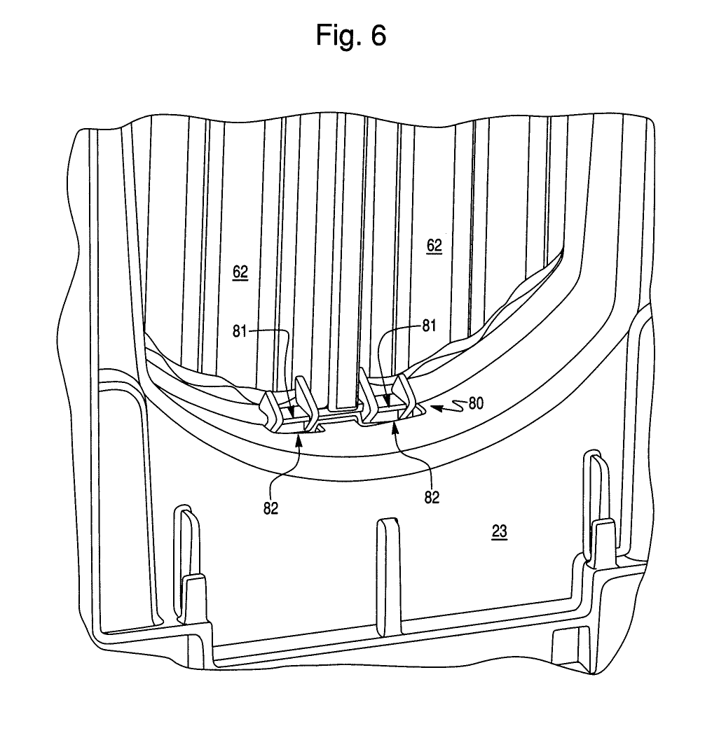

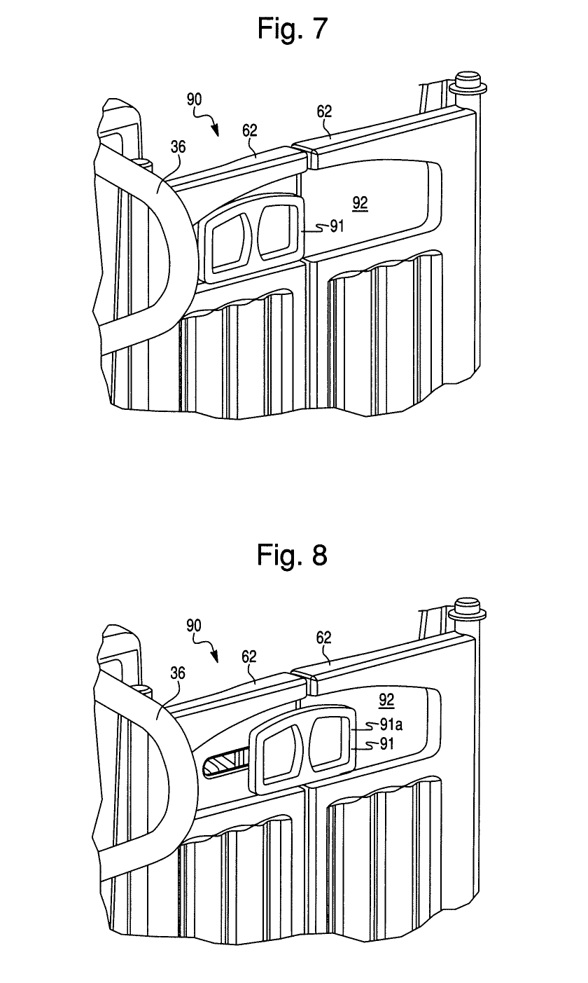

As shown in FIG. 6, the detent structure 80 includes a projection 81 that extends from the door and a recess 82 in the molded section of lower portion 23 of the rear wall 22. Due to the play of the doors 62 in the vertical direction, they can be lifted upwards such that the projections 81 can be lifted out of the recesses 82 so the doors 62 can swing open. When the doors 62 are swung closed, the projections 81 fall into the recesses 82 to hold the doors 62 closed.

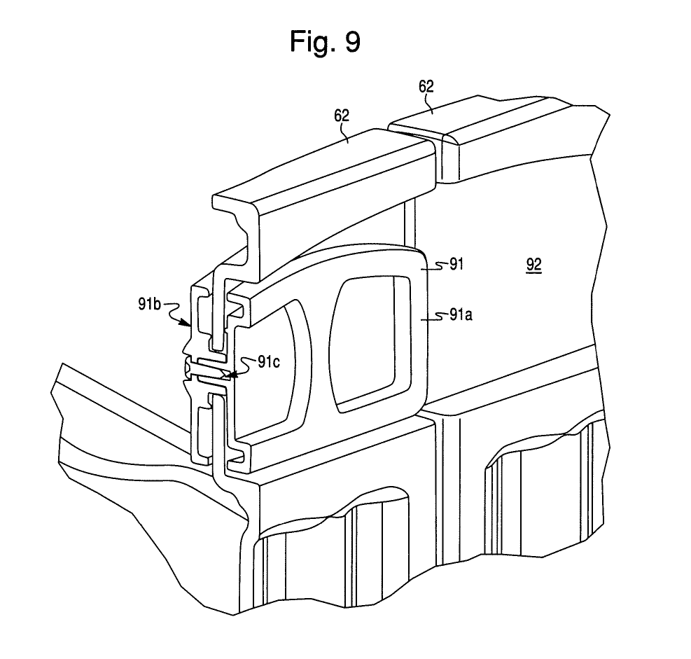

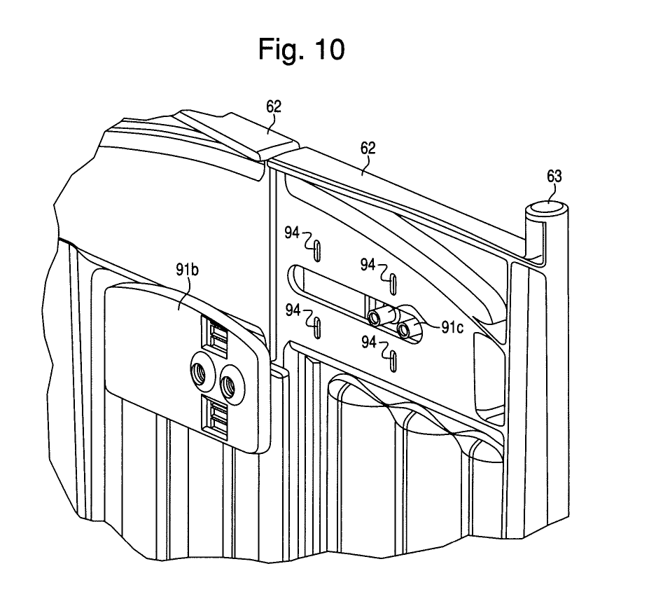

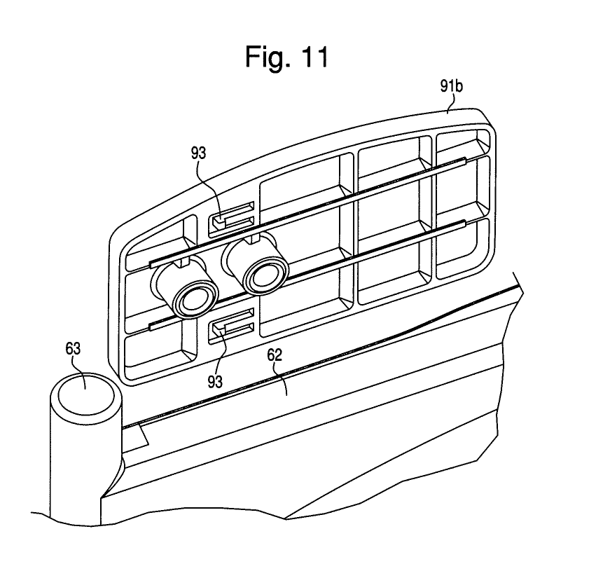

As shown in FIGS. 7 to 11, the latch member 90 includes a panel member 91 that moves between an unlocked position (FIG. 7) and a locked position (FIG. 8). The panel member 91 slides within a groove 92 formed in the doors 62. The panel member 91 is formed of two plates 91a, 91b connected by pins 91c. The interior plate 91b includes projections 93 (FIG. 11) that fit into recesses 94 (FIG. 10) in one of the doors 62 to hold it in either of the unlocked and locked positions.

Handles 36 are provided on the upwardly extending portions 23a of the rear wall 22 to allow a user to manipulate the portable receptacle 10. According to an exemplary embodiment, the handles 36 have a generally circular cross-section form arcs that extend out from the rear of the main body 12. The handles 36 may be integrally formed with the main body 12 or may be coupled to the container with mechanical fasteners or another suitable method.

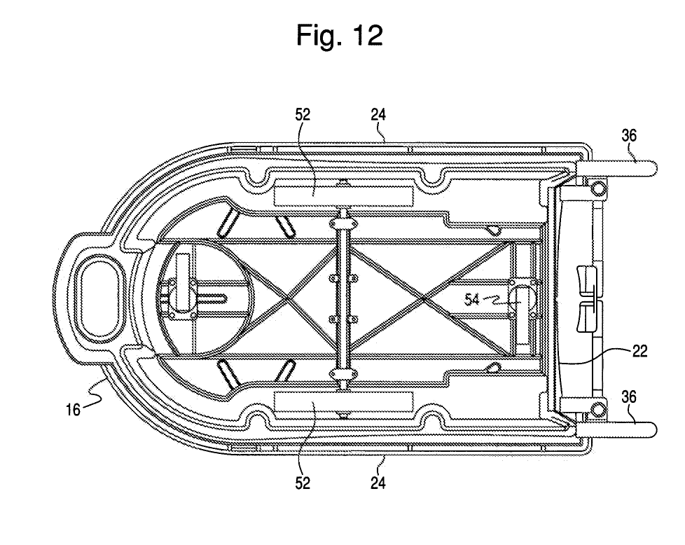

Rolling members 50 are coupled to the floor 14 of the main body 12 and are configured to allow a user to move the receptacle 10. According to one exemplary embodiment, the rolling members 50 include two first fixed-axis wheels 52 and two second smaller wheels 54 (e.g., casters, etc.). As shown best in FIG. 12, The rolling members 50 are arranged in a diamond pattern with the first wheels 52 provided proximate to the side walls 24 and the second wheels 54 provided proximate to the rear 22 and front 16 walls. The diamond pattern arrangement of the rolling members 50 allow the receptacle 10 to turn in a small area.

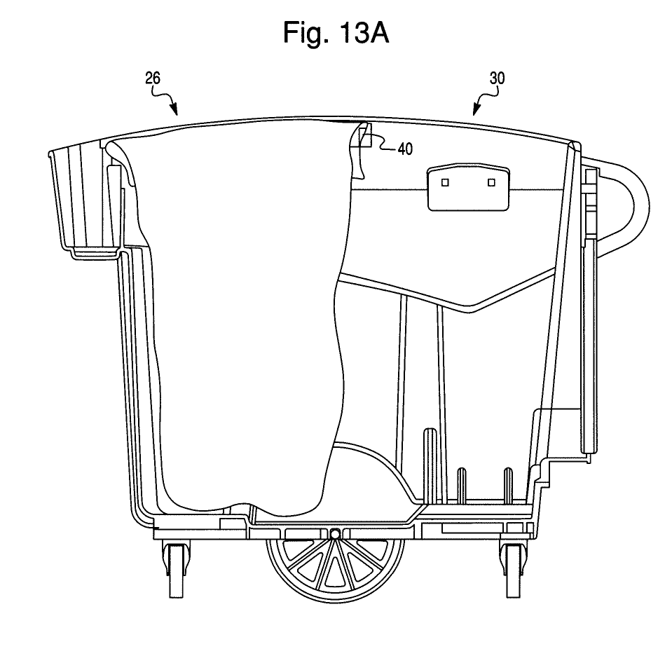

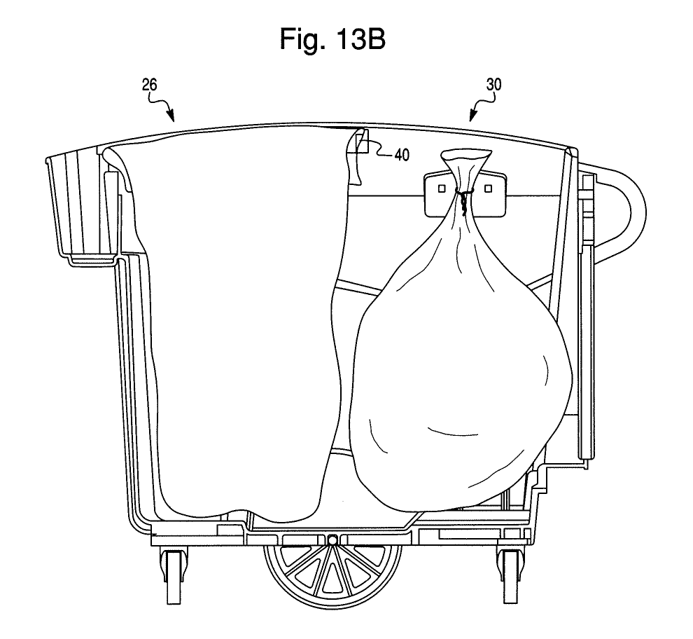

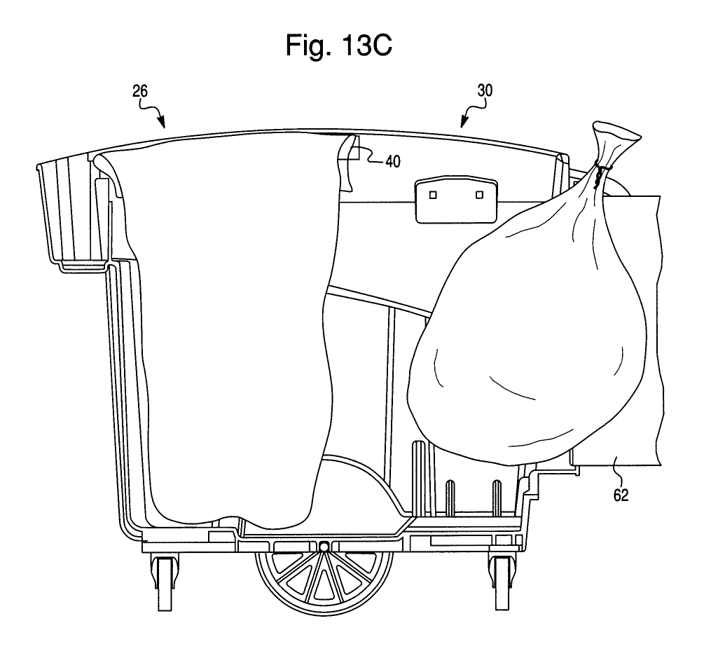

The portable receptacle 10 may be used to collect a single waste stream with the bag support 40 folded in a retracted position and no container 60 in the second portion 30 of the receptacle 10. The portable receptacle 10 may also be configured to receive a first bag by folding the bag support 40 into the use position, disposed between the first portion 26 and second portion 30 of the receptacle 10. A first bag is placed in the first portion 26 of the receptacle 10 and is supported by the bag support 40 and the support structure 20 as shown in FIG. 13A. When the first bag is at least partially filled, it is removed from the bag support 40 and support structure 20 and transferred from the first portion 26 to the second portion 30 and another bag is placed into in the first portion 26 as shown in FIG. 13B. One or more bags may be retained in the second portion 30 before being removed from the receptacle 10 through the doors 62 on the rear wall 22 as shown in FIG. 13C.

If a container 60 is in the second portion 30 of the receptacle 10, a bag may be removed from the first portion 26 and be retained between a bag in the first portion 26 and the container 60 in the second portion 30. The bag may be removed through the doors 62 on the rear wall 22 after the container 60 is removed from the second portion 30 of the receptacle 10.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

Although the invention has been described above by reference to certain embodiments of the invention, the invention is not limited to the embodiments described above. Modifications and variations of the embodiments described above will occur to those skilled in the art in light of the above teachings.

What is claimed is:

1. A portable receptacle comprising:
a container having an open top and including a first portion defining a first space;
configured to receive a first bag and having a support member to support at least a portion of the periphery of the first bag, and
a second portion defining a second space configured to receive a second bag;
a bag support including structure for connection to the container such that the bag support
can be disposed between the first portion and the second portion in an orientation that permits the bag support in conjunction with the support member to support at least a portion of the periphery of the first bag such that at least a portion of the first bag is disposed within the first space, and relocated such that the bag support is no longer disposed between the first portion and the second portion; and
rolling members supporting the container for movement.

2. The portable receptacle of claim 1, wherein the bag support includes an elongated member.

3. The portable receptacle of claim 2, wherein the elongated member has a substantially arcuate shape.

4. The portable receptacle of claim 2, wherein the elongated member is pivotally mounted to the first portion.

5. The portable receptacle of claim 2, wherein the elongated member connects to the first portion substantially at ends of the elongated member.

6. The portable receptacle of claim 1, further comprising structure within the second portion of the container for positioning a rigid container.

7. The portable receptacle of claim 1, further comprising at least one door that forms a portion of a wall of the second compartment and permits removal of the second bag through the wall.

8. A method of filling bags in a portable receptacle comprising comprising:
moving into position a portable receptacle including
a container including
a first portion defining a first space configured to receive a first bag, and
a second portion defining a second space configured to receive a second bag;
a bag support including structure for connection to the container such that the bag support can be disposed between the first portion and the second portion and relocated such that the bag support is no longer disposed between the first portion and the second portion; and
rolling members supporting the container for movement;
placing a first bag on the bag support such that the first bag is in the first portion of the container;
at least partially filling the first bag; and
removing the first bag from the bag support and transferring the first bag to the second portion.
